(19) United States
(12) Patent Application Publication
(10) Pub. No.: US 2009/0231234 A1
(43) Pub. Date: Sep. 17, 2009

(54) PLASMA DISPLAY APPARATUS

(76) Inventors: Makoto Onozawa, Miyazaki (JP); Haruo Koizumi, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/720,936

(22) PCT Filed: Jun. 27, 2005
(86) PCT No.: PCT/JP05/11758

§ 371 Date: Jun. 6, 2007

(51) Int. Cl. G09G 3/28

(52) U.S. Cl. 345/60

(57) ABSTRACT

A plasma display apparatus wherein the unevenness in intensity between the electrode lines of a plasma display panel is reduced. In a plasma display apparatus, the temperature difference between the output elements of electrode drive circuits of a plurality of electrode groups is determined, and then a control signal, which is generated in accordance with the determined temperature difference, is used to control the gas discharge currents, which flow into a plurality of electrode groups, for example, odd-numbered electrodes and even-numbered electrodes, in such a manner that they are uniformly supplied, thereby preventing the unevenness in intensity between the electrode line.

### TECHNICAL FIELD

The present invention relates to a plasma display apparatus. To be more precise, preferred embodiments of the present invention provide a plasma display apparatus of which unevenness in luminance between electrode lines of a plasma display panel has been reduced.

### BACKGROUND ART

Conventionally, in the technological field of a plasma display apparatus, there are known devices of an Alternate Lighting of Surfaces (hereinafter, abbreviated as ALIS) method of adjacently placing multiple first and second electrodes and forming display lines among all the electrodes (refer to Patent Document 1 below).

A plasma display panel of the ALIS method performs a so-called interlaced scan. The interlaced scan adjacently and alternately places n (512 for instance) odd-numbered electrodes and even-numbered electrodes of Y electrodes (first electrodes) and n+1 odd-numbered electrodes and even-numbered electrodes of X electrodes (second electrodes) and performs display emission among all display electrodes (Y and X electrodes) so as to perform display dividedly timewise between even-numbered lines and odd-numbered lines by forming 2n display lines with 2n+1 display electrodes.

FIG. 6 is a diagram showing an overview of a drive circuit of a conventional plasma display panel of the ALIS method. The X electrodes and Y electrodes are alternately placed in parallel, and address electrodes are placed in a vertical direction thereto. Reference character Y1 denotes an odd-numbered Y electrode, Y2 denotes an even-numbered Y electrode, X1 denotes an odd-numbered X electrode, and X2 denotes an even-numbered X electrode. The Y electrodes are connected to a scan driver SD. The scan driver SD is provided with a switch SW, which is switched to sequentially apply scan pulses in an address period. In a sustain discharge period, it is switched so that the odd-numbered Y electrode Y1 is connected to a first Y sustain circuit, and the even-numbered Y electrode Y2 is connected to a second Y sustain circuit. The odd-numbered X electrode X1 is connected to a first X sustain circuit, and an even-numbered X electrode X2 is connected to a second X sustain circuit. The address electrodes are connected to an address driver.

FIGS. 7 and 8 are diagrams showing drive waveforms of the conventional plasma display panel of the ALIS method. FIG. 7 shows the drive waveforms of odd-numbered fields, and FIG. 8 shows the drive waveforms of even-numbered fields. As shown in FIG. 7, in a reset period, voltage pulses are applied between all the X electrodes and Y electrodes, and initialization discharge is performed on all the display lines. The address period is divided into a first half and a second half. In the odd-numbered fields, the scan pulses are sequentially applied to the odd-numbered Y electrode (Y1) in the first half of the address period. In this case, a positive voltage is applied to the odd-numbered X electrodes (X1, X3), the even-numbered X electrode (X2) is put to a ground level, and a small negative voltage is applied to the even-numbered Y electrode (Y2). Therefore, address discharge is only performed on address lines where address pulses are applied between the odd-numbered X electrodes and the odd-numbered Y electrodes so as to accumulate wall charges. In the second half of the address period of the odd-numbered fields, the scan pulses are sequentially applied to the even-numbered Y electrode (Y2). The positive voltage is applied to the even-numbered X electrode (X2), the odd-numbered X electrodes (X1, X3) are put to the ground level, and the small negative voltage is applied to the odd-numbered Y electrode (Y1). Therefore, the address discharge is only performed between the even-numbered X electrodes and the even-numbered Y electrodes. Similarly, in the even-numbered fields, the address discharge is performed between the odd-numbered Y electrodes and the even-numbered X electrodes in the first half of the address period, and between the even-numbered Y electrodes and the odd-numbered X electrodes in the second half of the address period as shown in FIG. 8. Thus, the charges corresponding to display data are accumulated on odd-numbered display lines. In the sustain discharge period, reversed-phase sustain pulses are applied between the odd-numbered X electrodes and the odd-numbered Y electrodes and between the even-numbered X electrodes and the even-numbered Y electrodes so as to perform the sustain discharge, that is, the display emission on the odd-numbered display lines.

As a conventional technology relating to the plasma display apparatus, Patent Document 2 described below discloses a plasma display apparatus which suppresses unevenness in voltage drops generated according to wiring length from an electrode drive circuit to the electrodes for equalizing discharge currents flowing to the odd-numbered electrodes and the even-numbered electrodes so as to improve image quality.

Patent Document 1: Japanese Patent Publication No. 2801893

Patent Document 2: Japanese Patent Laid-Open Publication No. 2002-196719

As for the conventional plasma display apparatus for supplying the discharge currents to the odd-numbered electrodes and the even-numbered electrodes, there was a problem that the lines corresponding to the odd-numbered electrodes are dark and the lines corresponding to the even-numbered electrodes become dark so that a difference in luminance arises between the lines.

As a result of considering the unevenness in luminance, the following was clarified. On resistance of a power MOSFET used for an output element of the sustain circuit changes according to temperature. When the temperature becomes high, the on resistance becomes high. In the case of mounting a sustain substrate having the sustain circuit placed thereon, placing sustain output elements for the odd-numbered electrodes on the upper side of the sustain substrate and placing the sustain output elements for the even-numbered electrodes on the lower side of the sustain substrate, ambient temperature rises around the sustain output elements for the odd-numbered electrodes placed on the upper side so that temperature resistance of the sustain output elements becomes higher. As a result of this, a gas discharge current does not easily pass through the sustain output elements for the odd-numbered electrodes placed on the upper side in comparison with the sustain output elements for the even-numbered electrodes placed on the lower side. Thus, the gas discharge currents supplied to the odd-numbered electrodes are different from the gas discharge currents supplied to the even-numbered electrodes. Due to the difference in the gas discharge currents passing through them, the lines corresponding to the odd-numbered electrodes are dark and the lines corresponding to the even-numbered electrodes become dark so that a difference in luminance arises between the lines.

The difference in luminance is referred to as 2-line unevenness. According to the conventional example, no consideration was given to a cause of the problem or a method for solving the problem of the 2-line unevenness.

The problem to be solved by the present invention is to reduce the 2-line unevenness correspondingly to clarification of the cause of the difference in luminance.

### DISCLOSURE OF THE INVENTION

Of multiple electrode groups such as odd-numbered electrode drive circuits and even-numbered electrode drive circuits for supplying discharge currents to the odd-numbered electrodes and even-numbered electrodes, a plasma display apparatus of the present invention increases impedance of the drive circuits placed on a lower side, reduces unbalance of the discharge currents due to temperature and improves 2-line unevenness. To be more precise, the plasma display apparatus of the present invention is most characterized by detecting the temperature of output elements of the drive circuits and controlling the discharge currents so as to evenly supply gas discharge currents flowing to multiple electrode groups such as those flowing to the odd-numbered electrodes and those flowing to even-numbered electrodes.

According to the present invention, it is possible to equalize the gas discharge currents flowing to the odd-numbered electrodes and the even-numbered electrodes and reduce the 2-line unevenness for instance.

### BRIEF DESCRIPTION OF THE DRAWINGS

FIG. 1 is a sustain circuit of a plasma display apparatus of the present invention (first embodiment);

FIG. 2 is a sustain circuit of the plasma display apparatus of the present invention (second embodiment);

FIG. 3 is a sustain substrate of the plasma display apparatus of the present invention (second embodiment);

FIG. 4 is a sustain circuit of the plasma display apparatus of the present invention (third embodiment);

FIG. 5 is a sustain substrate of the plasma display apparatus of the present invention (third embodiment);

FIG. 6 is a diagram showing an overview of a drive circuit for a plasma display apparatus of the ALIS method in a conventional example;

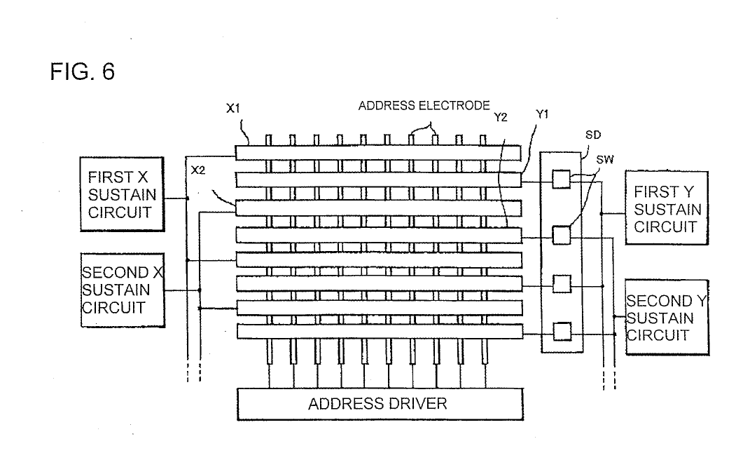

FIG. 7 is a diagram showing drive waveforms of odd-numbered fields of a plasma display panel of the ALIS method in a conventional example; and

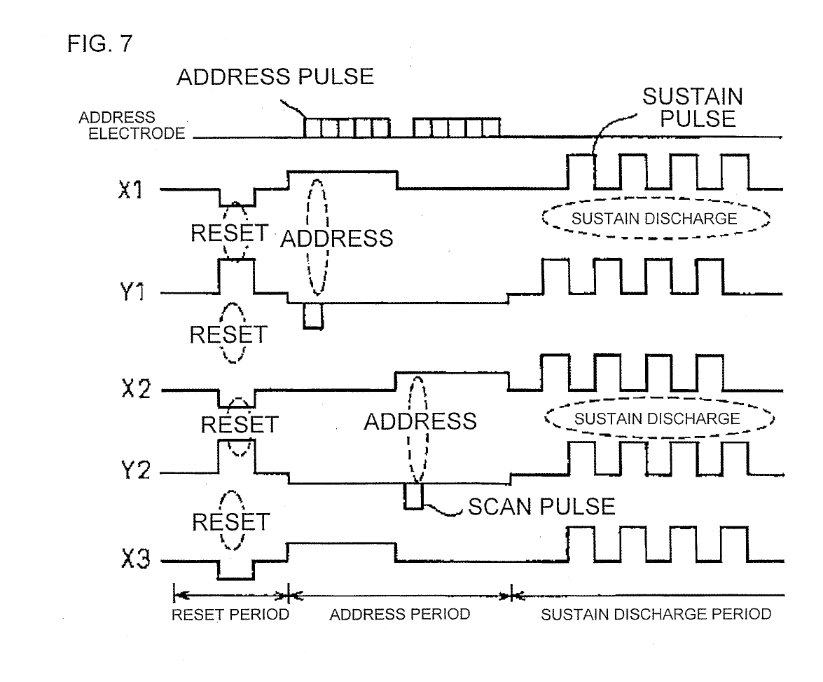

FIG. 8 is a diagram showing the drive waveforms of even-numbered fields of the plasma display panel of the ALIS method in a conventional example.

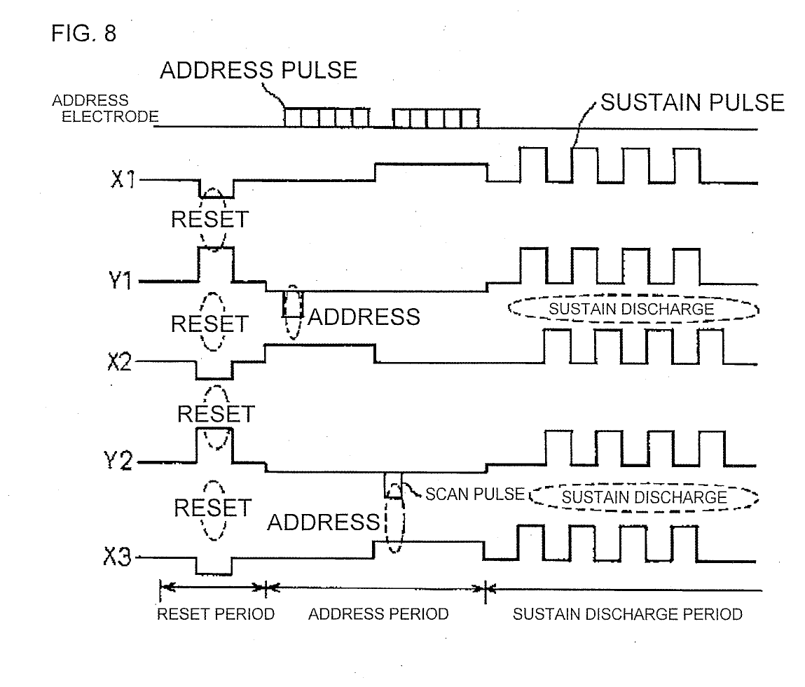

### DESCRIPTION OF SYMBOLS

1 Plasma display panel
2 Sustain substrate

### BEST MODE FOR CARRYING OUT THE INVENTION

Hereunder, embodiments of the present invention will be described by using the drawings.

### First Embodiment

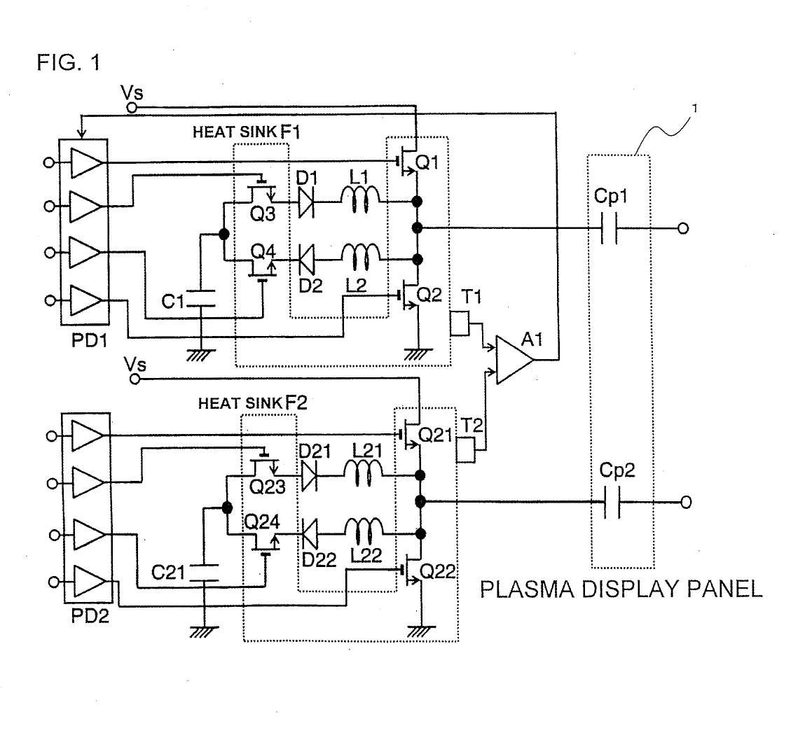

FIG. 1 shows a first embodiment of a sustain circuit of a plasma display apparatus according to the present invention. Reference character PD1 of FIG. 1 denotes a pre-drive circuit for odd-numbered electrodes. PD1 supplies drive pulses for driving output elements Q1, Q2, Q3 and Q4. Reference character PD2 denotes a pre-drive circuit for even-numbered electrodes. PD2 supplies the drive pulses for driving output elements Q21, Q22, and Q24.

In the circuit shown in FIG. 1, reference characters T1 and T2 denote temperature detection means which are configured by using diodes, thermistors and the like. Reference character A1 denotes a temperature difference detection circuit which detects, from a signal corresponding to the temperature difference detected by T1 and T2, a temperature difference between the two and forms a control signal. Based on the control signal outputted from the temperature difference detection circuit A1, amplitude is changed as to the drive pulses for driving the output elements Q1, Q2, Q3 and Q4 supplied by the pre-drive circuit for odd-numbered electrodes.

The amplitude is increased as to the drive pulses for driving the output elements Q1, Q2, Q3 and Q4 supplied by the pre-drive circuit for odd-numbered electrodes. It is thereby possible to reduce on resistance of the output elements Q1, Q2, Q3 and Q4 and increase gas discharge currents to be supplied to an odd-numbered electrode Cp1 of a plasma display 1. As a result of this, even when the temperature of the output elements Q1, Q2, Q3 and Q4 becomes higher than the temperature of the output elements Q21, Q22, Q23 and Q24, it is possible to equalize the gas discharge currents to be supplied to the odd-numbered electrodes and even-numbered electrodes and reduce the 2-line unevenness.

The output elements Q1, Q2, Q3 and Q4 and the output elements Q21, Q22, Q23 and Q24 are mounted on heat sinks F1 and F2 respectively. Therefore, it is possible, by providing the temperature detection means T1 and T2 on the heat sinks F1 and F2, to detect the temperature of the output elements Q1, Q2, Q3 and Q4 and the output elements Q21, Q22, Q23 and Q24.

According to the first embodiment, it detects the temperature difference, forms the control signal to be supplied to the pre-drive circuit for odd-numbered electrodes and increases the amplitude of the drive pulses outputted by the pre-drive circuit for odd-numbered electrodes. It is thereby possible to reduce on resistance of the output elements Q1, Q2, Q3 and Q4 and increase the gas discharge currents to be supplied to an odd-numbered electrode Cp1 of the plasma display 1. Therefore, it is possible to replenish the gas discharge currents of the output elements where the gas discharge currents became less passable due to temperature rise, equalize the gas discharge currents in a stable form and reduce the 2-line unevenness.

### Second Embodiment

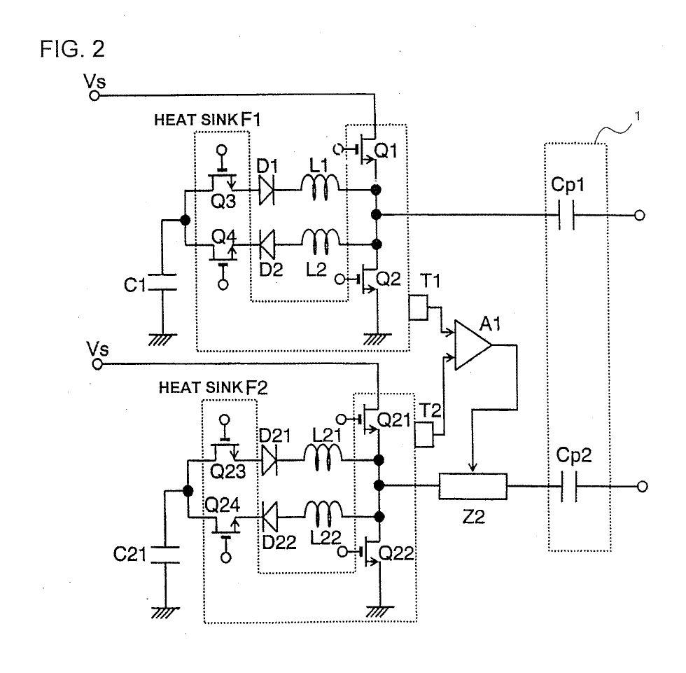

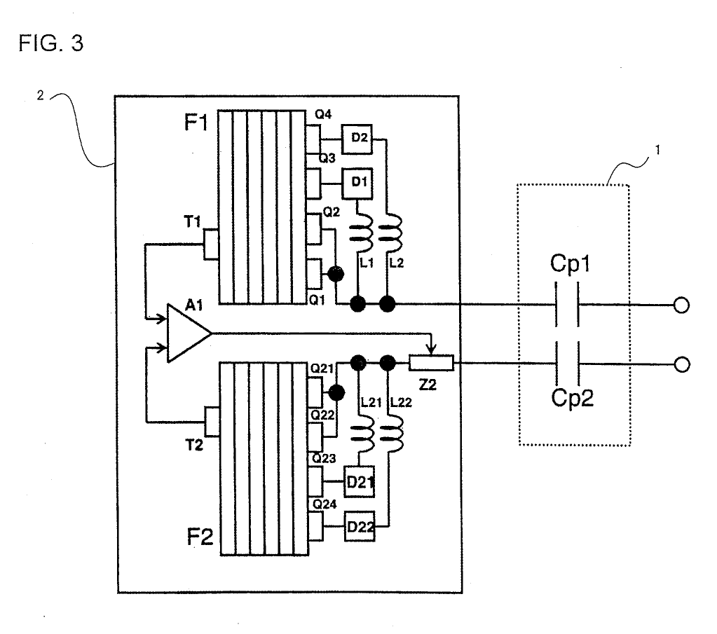

FIG. 2 shows a second embodiment of the sustain circuit of the plasma display apparatus according to the present invention. FIG. 3 shows an embodiment of a sustain substrate on which the circuit shown in FIG. 2 is mounted.

Reference character PD1 of FIG. 2 denotes a pre-drive circuit for odd-numbered electrodes. PD1 supplies drive pulses for driving the output elements Q1, Q2, Q3 and Q4. Reference character PD2 denotes a pre-drive circuit for even-numbered electrodes. PD2 supplies the drive pulses for driving the output elements Q21, Q22, Q23 and Q24.

In the circuit shown in FIG. 2, reference characters T1 and T2 denote temperature detection means which are configured by using diodes, thermistors and the like. Reference character Z2 denotes a discharge current control means for controlling the gas discharge currents flowing to an even-numbered electrode Cp2 of the plasma display panel 1. Reference character A1 denotes a temperature difference detection circuit which detects, from a signal corresponding to the temperature difference detected by T1 and T2, a temperature difference between the two and forms a control signal to be supplied to the discharge current control means Z2.

Based on the control signal outputted from the temperature difference detection circuit A1, the discharge current control means Z2 exerts control to change the gas discharge currents flowing to the even-numbered electrode Cp2 of the plasma display panel 1 so that the gas discharge currents flowing to the odd-numbered electrode Cp1 of the plasma display panel 1 and the gas discharge currents flowing to the even-numbered electrode Cp2 become almost equal.

The sustain circuit shown in FIG. 2 is mounted on the sustain substrate 2 shown in FIG. 3, and the heat sinks F1 and F2 are mounted on the sustain substrate 2. The output elements Q1, Q2, Q3 and Q4 and the output elements Q21, Q22, Q23 and Q24 are mounted on the heat sinks F1 and F2 respectively. Therefore, it is possible, assuming that the temperature in the heat sinks F1 and F2 is almost constant, to detect the temperature difference in the temperature difference detection circuit A1 from outputs of the temperature detection means T1 and T2 provided on the heat sinks F1 and F2 and use it as a signal corresponding to the temperature difference between the output elements Q1, Q2, Q3 and Q4 and the output elements Q21, Q22, Q23 and Q24 so as to exert control so that the gas discharge currents flowing to the odd-numbered electrode Cp1 and the even-numbered electrode Cp2 of the plasma display panel 1 become almost equal.

The sustain circuit shown in FIG. 2 may be used to equalize the gas discharge currents flowing to the odd-numbered electrodes and the gas discharge currents flowing to the even-numbered electrodes so as to reduce the 2-line unevenness.

According to the second embodiment, it directly controls the gas discharge currents flowing to the even-numbered electrode Cp2 of the plasma display panel 1 from the output elements Q21, Q22, Q23 and Q24 by the control signal supplied from the discharge current control means Z2. Therefore, it is possible to promptly and accurately control the gas discharge currents by electrical control means.

### Third Embodiment

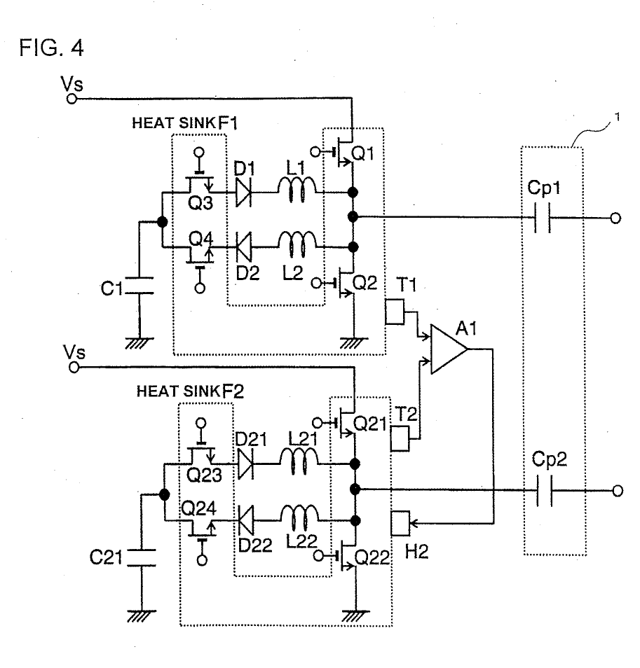

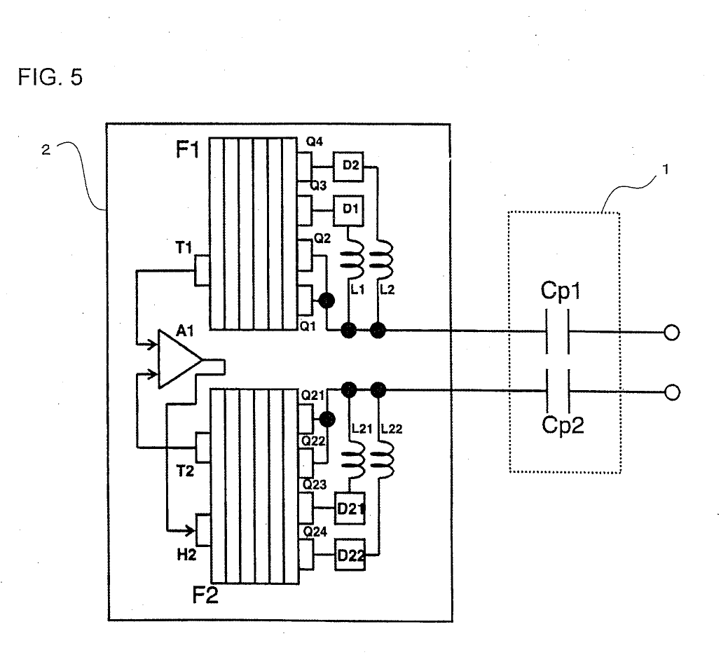

FIG. 4 shows a third embodiment of the sustain circuit of the plasma display apparatus according to the present invention. FIG. 5 shows an embodiment of a sustain substrate on which the circuit shown in FIG. 4 is mounted. Reference character H2 of FIG. 5 denotes heating means which is configured by using a heater and the like. In FIG. 5, reference character A1 denotes a temperature difference detection circuit which detects, from a signal corresponding to the temperature difference detected by T1 and T2, a temperature difference between the two and forms a control signal to be supplied to the heating means H2. Based on the control signal inputted from the above A1, the heating means performs a function of heating the heat sink F2 to set its temperature equal to the heat sink F1. As a result of this, the temperature of the output elements Q1, Q2, Q3 and Q4 mounted on the heat sink F1 becomes equal to the temperature of the output elements Q21, Q22, Q23 and Q24 mounted on the heat sink F2. Thus, it is possible to equalize the gas discharge currents supplied to the odd-numbered electrodes and the even-numbered electrodes and reduce the 2-line unevenness.

According to the third embodiment, it detects the temperature difference of the output elements and equalizes the temperature by using the heating means. Therefore, it is possible to realize discharge current control means for controlling the discharge currents from the output elements in a simple configuration.

According to the above embodiments, it is described that the present invention is intended to solve unevenness in luminance of odd-numbered electrode lines and even-numbered electrode lines of a conventional plasma display apparatus of the ALIS method. However, the present invention is not limited to the above method but is also applicable, for the sake of solving the unevenness in luminance due to the temperature difference, to the plasma display apparatus which divides the first electrode or the second electrode into multiple electrode groups to supply driving power respectively.

### Other Embodiments

The present invention has various configuration examples according to differences in configurations of the X electrode and Y electrode and configurations of a temperature detection element and discharge current limiting means. Hereunder, the configuration examples of the present invention will be described as additional statements.

### Additional Statement 1

A plasma display apparatus including:

multiple X electrodes;

multiple Y electrodes alternately placed adjacently to the multiple X electrodes and generating discharge between themselves and the multiple X electrodes;

a first X electrode drive circuit for applying discharge voltage to odd-numbered electrodes of the multiple X electrodes;

a second X electrode drive circuit for applying the discharge voltage to even-numbered electrodes of the multiple X electrodes;

a first Y electrode drive circuit for applying the discharge voltage to odd-numbered electrodes of the multiple Y electrodes; and

a second Y electrode drive circuit for applying the discharge voltage to even-numbered electrodes of the multiple Y electrodes,

characterized in that:

the apparatus is provided with:

first temperature detection means for detecting temperature of a heat sink mounted on an output element of the first X electrode drive circuit;

second temperature detection means for detecting temperature of a heat sink mounted on an output element of the second X electrode drive circuit;

first temperature difference detection circuit connected to the first temperature detection means and the second temperature detection means; and

first discharge current control means connected to the first temperature difference detection circuit.

### Additional Statement 2

A plasma display apparatus including:

multiple X electrodes;

multiple Y electrodes alternately placed adjacently to the multiple X electrodes and generating discharge between themselves and the multiple X electrodes;

a first X electrode drive circuit for applying discharge voltage to odd-numbered electrodes of the multiple X electrodes;

a second X electrode drive circuit for applying the discharge voltage to even-numbered electrodes of the multiple X electrodes;

a first Y electrode drive circuit for applying the discharge voltage to odd-numbered electrodes of the multiple Y electrodes; and

a second Y electrode drive circuit for applying the discharge voltage to even-numbered electrodes of the multiple Y electrodes,

characterized in that:

the apparatus is provided with:

third temperature detection means for detecting temperature of a heat sink mounted on an output element of the first Y electrode drive circuit;

fourth temperature detection means for detecting temperature of a heat sink mounted on an output element of the second Y electrode drive circuit;

second temperature difference detection circuit connected to the third temperature detection means and the fourth temperature detection means; and

second discharge current control means connected to the second temperature difference detection circuit.

### Additional Statement 3

A plasma display apparatus including:

multiple X electrodes;

multiple Y electrodes alternately placed adjacently to the multiple X electrodes and generating discharge between themselves and the multiple X electrodes;

a first X electrode drive circuit for applying discharge voltage to odd-numbered electrodes of the multiple X electrodes;

a second X electrode drive circuit for applying the discharge voltage to even-numbered electrodes of the multiple X electrodes;

a first Y electrode drive circuit for applying discharge voltage to odd-numbered electrodes of the multiple Y electrodes; and

a second Y electrode drive circuit for applying the discharge voltage to even-numbered electrodes of the multiple Y electrodes,

characterized in that:

the apparatus is provided with:

first temperature detection means for detecting temperature of a heat sink mounted on an output element of the first X electrode drive circuit;

second temperature detection means for detecting temperature of a heat sink mounted on an output element of the second X electrode drive circuit;

first temperature difference detection circuit connected to the first temperature detection means and the second temperature detection means;

first discharge current control means connected to the first temperature difference detection circuit;

third temperature detection means for detecting temperature of a heat sink mounted on an output element of the first Y electrode drive circuit;

fourth temperature detection means for detecting temperature of a heat sink mounted on an output element of the second Y electrode drive circuit;

second temperature difference detection circuit connected to the third temperature detection means and the fourth temperature detection means; and

second discharge current control means connected to the second temperature difference detection circuit.

### Additional Statement 4

The plasma display apparatus according to the additional statements 1 to 3, characterized in that:

the discharge current control means is impedance control means capable of changing impedance by a supplied voltage or current.

### Additional Statement 5

The plasma display apparatus according to the additional statement 4, characterized in that:

the discharge current control means is configured by using semiconductor devices.

### Additional Statement 6

The plasma display apparatus according to the additional statements 1 to 5, characterized in that:

the discharge current control means controls a discharge current passing through the output element placed on a downside of a plasma display panel out of the first X electrode drive circuit and the second X electrode drive circuit.

### Additional Statement 7

The plasma display apparatus according to the additional statements 1 to 5, characterized in that:

the discharge current control means controls a discharge current passing through the output element placed on the downside of the plasma display panel out of the first Y electrode drive circuit and the second Y electrode drive circuit.

### Additional Statement 8

The plasma display apparatus according to the additional statements 1 to 7, characterized in that:

the discharge current control means controls amplitude of drive voltage supplied to the output element placed on an upside of the plasma display panel out of the first X electrode drive circuit and the second X electrode drive circuit.

### Additional Statement 9

The plasma display apparatus according to the additional statements 1 to 7, characterized in that:

the discharge current control means controls amplitude of drive voltage supplied to the output element placed on the upside of the plasma display panel out of the first Y electrode drive circuit and the second Y electrode drive circuit.

### Additional Statement 10

The plasma display apparatus according to the additional statements 1 to 3, characterized in that:

the discharge current control means is heating means for increasing temperature of the heat sink of the output element placed on the downside of the plasma display panel.

### Additional Statement 11

The plasma display apparatus according to the additional statement 1, characterized in that:

the heat sink mounted on the output element of the first X electrode drive circuit and the heat sink mounted on the output element of the second X electrode drive circuit are different heat sinks; and

the heat sink mounted on the output element of the first X electrode drive circuit and the heat sink mounted on the output element of the second X electrode drive circuit are placed on the same printed board.

### Additional Statement 12

The plasma display apparatus according to the additional statement 2, characterized in that:

the heat sink mounted on the output element of the first Y electrode drive circuit and the heat sink mounted on the output element of the second Y electrode drive circuit are different heat sinks; and

the heat sink mounted on the output element of the first Y electrode drive circuit and the heat sink mounted on the output element of the second Y electrode drive circuit are placed on the same printed board.

### Additional Statement 13

The plasma display apparatus according to the additional statement 3, characterized in that:

the heat sink mounted on the output element of the first X electrode drive circuit and the heat sink mounted on the output element of the second X electrode drive circuit are different heat sinks; and

the heat sink mounted on the output element of the first X electrode drive circuit and the heat sink mounted on the output element of the second X electrode drive circuit are placed on the same printed board, and further,

the heat sink mounted on the output element of the first Y electrode drive circuit and the heat sink mounted on the output element of the second Y electrode drive circuit are different heat sinks; and

the heat sink mounted on the output element of the first Y electrode drive circuit is placed on the same printed board.

### Additional Statement 14

The plasma display apparatus according to the additional statements 1 to 3, characterized in that:

the temperature detection means are configured by using diodes.

### Additional Statement 15

The plasma display apparatus according to the additional statements 1 to 3, characterized in that:

the temperature detection means are configured by using thermistors.

### Additional Statement 16

The plasma display apparatus according to the additional statements 1 to 3, characterized in that:

the temperature difference detection circuit compares output signals of multiple temperature detection means, and supplies a control signal based on information obtained as a result thereof the discharge current control means.

### Additional Statement 17

The plasma display apparatus according to the additional statement 16, characterized in that:

the temperature difference detection circuit supplies a control signal to the discharge current control means based on a voltage difference generated at both ends of multiple diodes used as the temperature detection means.

### Additional Statement 18

The plasma display apparatus according to the additional statement 16, characterized in that:

the temperature difference detection circuit supplies a control signal to the discharge current control means based on a voltage difference generated at both ends of multiple thermistors used as the temperature detection means.

### Additional Statement 19

A plasma display apparatus characterized in that:

the configuration of the additional statement 1 is provided to a plasma display apparatus of the ALIS method.

### Additional Statement 20

A plasma display apparatus characterized in that:

the configuration of the additional statement 2 is provided to a plasma display apparatus of the ALIS method.

### Additional Statement 21

A plasma display apparatus characterized in that:

the configuration of the additional statement 3 is provided to a plasma display apparatus of the ALIS method.

1. A plasma display apparatus including:
multiple first electrodes;
multiple second electrodes alternately placed adjacently to the multiple first electrodes and generating discharge between themselves and the multiple first electrodes; and
multiple electrode drive circuits for, as to the multiple first electrodes and the multiple second electrodes at least one of which are divided into multiple electrode groups, applying discharge voltage to the multiple electrode groups,
characterized in that:
the apparatus is provided with:
multiple temperature detection means for detecting temperature of output elements of the multiple electrode drive circuits;
a temperature difference detection circuit connected to the multiple temperature detection means; and
discharge current control means connected to the temperature difference detection circuit,
wherein a temperature difference of the output elements of the multiple electrode drive circuits is detected and control is exerted to evenly supply discharge currents flowing to the multiple electrode groups of a plasma display panel.

2. The plasma display apparatus according to claim 1, characterized in that:
the first electrodes are X electrodes, and the second electrodes are Y electrodes; and
the multiple electrode groups are odd-numbered electrode groups and even-numbered electrode groups of multiple X electrodes, odd-numbered electrode groups and even-numbered electrode groups of multiple Y electrodes or odd-numbered electrode groups and even-numbered electrode groups of multiple X electrodes and multiple Y electrodes.

3. The plasma display apparatus according to claim 1 or 2, characterized in that:
the multiple temperature detection means detect temperature of each of heat sinks mounted on the output elements of the multiple electrode drive circuits.

4. The plasma display apparatus according to claims 1 to 3, characterized in that:
the discharge current control means controls amplitude of drive voltage supplied to the output elements of the multiple electrode drive circuits so as to exert control to evenly supply discharge currents.

5. The plasma display apparatus according to claims 1 to 3, characterized in that:
the discharge current control means exerts control to evenly supply discharge currents from the output elements of the multiple electrode drive circuits by impedance control or control by semiconductor devices.

6. The plasma display apparatus according to claims 1 to 3, characterized in that:
the discharge current control means exerts control to evenly supply discharge currents by increasing the temperature of the output elements through use of heating means provided to at least one of the heat sinks of the output elements of the multiple electrode drive circuits.
